(19) United States
(12) Patent Application Publication
(10) Pub. No.: US 2011/0150734 A1
(43) Pub. Date: Jun. 23, 2011

(54) Photo-Catalytic Membrane Reactor

(75) Inventors: Izumi Kumakiri, Oslo (NO); Rune Bredesen, Oslo (NO); Henrik Reader, Oslo (NO); Christian Simon, Oslo (NO)

(73) Assignee: SINVENT AS, Trondheim (NO)

(21) Appl. No.: 13/059,564

(22) PCT Filed: Aug. 18, 2009
(86) PCT No.: PCT/NO09/00290

§ 371 Date: Feb. 17, 2011

(30) Foreign Application Priority Data
Aug. 18, 2008 (NO) 20083579

(51) Int. Cl. B01J 19/12; C02F 1/70; C02F 1/72; C02F 1/32; C02F 1/48; B01D 53/72; B01J 8/02

(52) U.S. Cl. 423/245.1; 210/748.01; 210/668; 210/748.14; 210/748.08; 210/748.09; 422/211

(57) ABSTRACT

A process and reactor for liquid or gas treatment by photocatalytic reaction by using a catalytic membrane reactor comprising a pourous membrane as a contactor between two phases, that can be liquid or gas, a catalyst material and a liquid or gas phase, wherein as the catalyst material a phytocatalyst and/or change-transfer catalyst are used, and the liquid or gas is illuminated by a light source.

### CROSS-REFERENCE TO RELATED APPLICATIONS

This application is a 35 U.S.C. §371 national stage application of PCT/NO2009/000290 filed Aug. 18, 2009, which claims the benefit of Norwegian Application No. 20083579 filed Aug. 18, 2008, both of which are incorporated herein by reference in their entireties for all purposes.

### STATEMENT REGARDING FEDERALLY SPONSORED RESEARCH OR DEVELOPMENT

Not applicable.

The present invention relates to a process and a reactor for liquid or gas treatment. One typical application is to treat water containing hardly degradable organics. In this case, the process is based on the same principles as catalytic wet air oxidation, but it is accomplished by the combined use of a porous membrane contactor, photocatalysts, and a light source. The photocatalytic membrane contactor is not limited to liquid-gas contactor applications but may also be employed in liquid-liquid or gas-gas photo-catalytic applications.

### BACKGROUND

Water quality is calling more and more attention and demand on the access to high quality clean water is increasing. For example, pesticides and other natural organic components in drinking water are possible human carcinogens by themselves or when they react with chlorine, which is widely used in the treatment of portable water today. The regulations of industrial effluents, landfill effluents and other effluents are getting stricter towards zero-emissions in Europe and in other countries. Accordingly, the demands on cost effective and simple water treatment processes that can treat dilute and toxic liquids are increasing.

Several technologies for the abatement of the chemical oxygen demand (COD), which is a function of pollutant concentration, in wastewater exist. Treatment of wastewaters with low to medium COD containing biodegradable and non-toxic chemicals can be achieved in an economical and efficient way by using biological techniques which, however, require large installations. On the other hand, incineration can be an appropriate technique to treat high COD effluents provided adequate fume treatment. However, destruction techniques for low to medium COD effluents, containing non-biodegradable or toxic compounds, are limited.

Wet air oxidation (WAO) processes that involve the oxidation of organic compounds in water at temperatures up to 300° C. and at pressures up to 200 bar were developed in the 1950's. Later, more efficient catalytic WAO processes have been developed based on heterogeneous catalysis. However, existing catalytic WAO processes require high temperatures (>150° C.) and pressures, associated with high energy consumption and reactor corrosion problems, which severely affects the economy of this technology.

A method combining two processes, catalytic WAO and catalytic membrane contactor (CMC), is called the WaterCatox process and is described in WO02/074701. This emerging technique made it possible to achieve oxidation in liquid phase at a lower pressure (e.g. <10 bar) and temperature (<80° C.) than what is feasible with the conventional processes for wet oxidation and combustion. In addition, the WaterCatox process has lower space requirements compared with conventional processes for biological treatment of waste.

The WaterCatox process is designed to oxidize organic effluents with oxygen from air so that a total mineralization is achieved with a much higher efficiency than by any other conventional techniques of wastewater treatment:

CₓH_{y} or CₓH_{y}O_{Z}→CO₂+H₂O

CₓH_{y}N(Cl,S)_{z}→CO₂+H₂O+N₂(Cl⁻,SO₄²⁻)

A 3-phase boundary system (gas, liquid, solid (catalyst)) can be achieved by applying a bubbler or by distributing gas through a porous membrane (U.S. Pat. No. 5,779,912). In this case, the pressure at the liquid side increases with the gas dose. Therefore, the process requires an additional separation step to release gas from the liquid line to maintain the pressure. In addition, a large part of the gas does not contribute to the oxidation reaction as it is only the dissolved oxygen that contributes to the reaction. In case of applying a porous membrane as a distributor, a gas layer may form on top of the membrane when the gas permeation rate is high or/and when the wetting property of the membrane is poor. The gas layer on top of the membrane prevents water and or ganics in water contacting the catalyst and inhibits the oxidation reaction.

On the contrary, the liquid and gas interface is maintained in the porous membrane contactor where catalysts are deposited in the WaterCatox process (e.g. WO 02/074701 A1). In this process gas does not permeate through the porous membrane to the liquid side and catalyst is deposited in the porous membrane. This configuration has several advantages, such as less gas consumption compared to distributors, stable pressure at the liquid side that gives easier control of the process and ensures continuous contact between liquid, gas and catalyst.

The advantage of the WaterCatox process has been demonstrated with e.g. a porous membrane contactor comprising a platinum catalyst, applied to the oxidation of formic acid dissolved in water (e.g. E. lojoiu et al. Applied Catalysis B: Environment 69, 196-206 (2007)). Industrial relevant oxidation rate was obtained under remarkably mild conditions; 20-8° C., ambient pressure on the liquid side, and less than 6 bar on the gas side.

The reaction rate depends strongly on the effluent composition. In addition, deactivation of the catalyst is observed with phenol containing solutions (e.g. E. lojoiu et al. Applied Catalysis B: Environment 69, 196-206 (2007)). Regeneration of the catalyst is possible at e.g. 200° C. heating in hydrogen but it requires extra facilities and the catalytic activity do not always recover fully by the treatment.

High reaction rate and longer catalyst lifetime are two important factors in the industrial application. Higher reaction rate implies that the reactor size can be reduced, which will reduce the capital cost and minimize the installation space. Longer lifetime of the catalytic membrane contactor will reduce the running cost.

Applications of fixed photocatalyst for use in water treatment have been reported (WO/2008/038529). Two major reactions exist in the oxidation of organics in water by photocatalysts as shown in FIG. 1. Light supplied to the photocatalyst creates holes and electrons in the photocatalysts. Holes are strong oxidants by themselves or by forming OH radicals and oxidize organics in water. Electrons have reducing properties. If oxygen is present, electrons and oxygen will form strong oxidizing components such as O₂⁻. Generally, the concentration of dissolved oxygen in water is small and the major oxidation of organics occurs by the holes generated by light in/on the photocatalyst. Supplying oxygen or air by a bubbler may increase the oxidation rate by additional oxidant formation (cf. e.g. JP 2000-263070A). As described above, the WaterCatox configuration has an advantage for the 3-phase (gas, liquid, solid (catalyst)) reaction.

Combination of photocatalyst and membrane filtration has been reported in the literature (Japanese patent, P2006-326530A). In the reported case, membrane is separating two gas phases having different pressures. A polluted gas with volatile organic components (VOCs) at the higher pressure side passes through the membrane where a photocatalyst is deposited. During the permeation through the membrane, VOCs are decomposed by photo-catalysis. The membranes must have very small pores, such as less than 10 nm, to achieve high decomposition rate. Preparing defect-free micro/meso-porous membranes at a large scale has various technical challenges today.

In the reported configuration, the conversion rate is determined by the balance between the gas flux through the membrane and the kinetics of the photo-catalysis. When a number of gaseous species contribute to the photo-catalytic reaction, all the gaseous species need to be mixed before the membrane reactor. As the flux through the membrane differs between the different gaseous species, the composition of the gas fed to the membrane surface may change along the membrane length and may lower the conversion or/and the selectivity of the reaction.

It is an object with the present invention to provide a process for treatment of gas and liquid with higher reaction rate at low temperature (<100° C.). Another object with the invention is to prolong the catalyst lifetime.

It has now been found that using photocatalysts in combination with some of the principles of the WaterCatox process gives a unique configuration that facilitates the transport of molecules to the catalytic surface. The new photo-catalytic process provides faster reaction rates compared to the reported WaterCatox process as the reaction occurs by both the metal catalyst and by the photocatalyst. In addition, photocatalysts will regenerate the metal catalyst in situ, during the liquid treatment as the photocatalyst has both oxidation and reduction properties. In this way, photocatalysts act not only to improve the oxidation, but also prolong the lifetime of the metal catalyst.

### DESCRIPTION OF THE INVENTION

The present invention provides a process for liquid and/or gas treatment by photocatalytic reaction by using a catalytic membrane reactor in which the liquid and/or gas phase to be treated and a second phase are separated by a porous membrane comprising a photocatalyst or a charge-transfer material. The liquid or gas is illuminated by a light source when photocatalyst is applied. In case of charge transfer catalyst, a long wave length light source can be used. The phase to be treated flows along one surface of the membrane, and the other phase flows along the other side of the membrane. The phase to be treated may be liquid or gas with organic contaminants, the second phase may be a liquid or a gas and may have oxidative or reductive properties. The catalyst material is a photocatalyst and/or charge-transfer catalyst. Reactants can be dispersed or dissolved in the liquid phase or in the gas phase and are supplied to one side of a membrane contactor. Examples of the different combinations of two phases are as follows: liquid/gas; organics in water on one side of the membrane and oxygen on the other side, gas/gas; organics in gas on one side of the membrane and oxygen on the other side; and as an example of both phases being in liquid form; organics in water on one side of the membrane and hydrogen peroxide on the other side.

Another aspect of the present invention is a catalytic membrane contactor for removal of organic matter in a fluid comprising a contactor 13 in form of a porous membrane comprising a catalyst material, said contactor being designed as a contactor between two phases, the two phases being either two gases, a gas and the other a liquid, or two liquids; the catalyst material constitutes the porous membrane or is deposited in or onto a porous membrane support, wherein the catalyst material comprises at least one of a photocatalyst and charge-transfer catalyst, and the reactor further comprises a light source 11. The light source may be any light source dependent on the catalyst to be used, examples are: UV-light, white light, IR light, sun light or electromagnetic radiation with longer wavelength than IR light in particular of charge transfer material.

### DESCRIPTION OF THE DRAWINGS

FIG. 1 shows the two major reactions in the oxidation of organics in water by photocatalysts.

FIG. 2 shows the principles of photocatalytic reaction in combination with a catalytic membrane contactor.

FIG. 3 shows a flow chart of a catalytic membrane reactor according to the invention.

FIGS. 4 and 5 show two examples of the light source installation.

FIG. 6 shows the microstructure of the catalytic membrane contactor.

FIG. 7 shows test results from treatment of water with organics (formic acid).

FIG. 8 shows test results from treatment of water with organics (humic acid), FIG. 9 shows test results from treatment of gas with organics (formic acid vapour).

FIGS. 10a, 10b and 10c show the change of UV absorption spectrum with time at three different test conditions for the treatment of gas with organics (formic acid vapour).

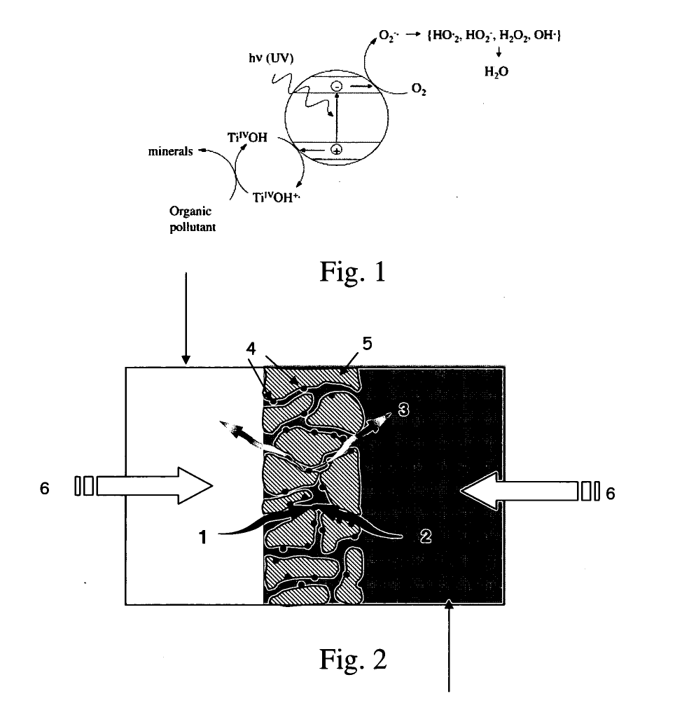

### DETAILED DESCRIPTION OF THE INVENTION

### Treatment of Liquid; Liquid/Gas Configuration

The photocatalyst may be placed at the metal catalyst position of the conventional WaterCatox process with or without metal catalyst. In addition, the photocatalyst can also be placed at the other side of the membrane to the conventional metal catalyst position. Reaction at the interface of two phases may form toxic volatile components that can evaporate through a membrane contactor and pollute the gas side. In the conventional WaterCatox process, these evaporated components can hardly be treated. The new photo-catalytic process, where metal catalyst and/or photocatalyst are/is placed at the conventional position and photocatalyst is placed at the other side of the membrane, has two catalytic layers in its structure. The configuration is profitable to treat organic components further and will significantly reduce the pollution in the exhaust gas if any organics forms in the gaseous phase by the catalytic reaction at the liquid and gas interface.

Photocatalysts such as titanium oxide (TiO₂) in combination with UV irradiation have been shown to be efficient in oxidation of chemical compounds. Recently, composite catalysts, such as doped-TiO₂, are reported to show photocatalytic activity under visible light. Generally the photocatalyst is introduced as particles of micrometer size or pellets in water treatment applications. When the catalyst is dispersed in water, extra processes are required to bubble oxygen into the solution and to separate and regenerate the catalyst. Some part of the catalyst is lost during separation and regeneration. In the WaterCatox process, on the contrary, the catalyst is fixed at the reaction field as particles in the catalytic membrane contactor. A photocatalytic process will offer close contact between oxygen, pollutant and light at the catalyst position, which is an ideal condition for high performance oxidation. Since photocatalysis has shown to improve the oxidation performance of the WaterCatox process, it will expand the application potential of the process substantially.

Treatment of Liquid; Liquid/Liquid Configuration

The photocatalytic membrane contactor is not limited to liquid-gas contactor applications, but may also be employed in liquid-liquid photocatalytic contactor applications. In the liquid-liquid application the oxidant can be any chemical dissolved in one of the liquids while the pollutant is dissolved in the other. The liquids may be immiscible or not, and the wetting properties of the porous contactor may, or may not, differ for the two liquids. As for the liquid-gas contactor, the main improvement by using photocatalytic contactor is to achieve a close contact between the photocatalyst, oxidant in one liquid, reductant in the other liquid and light by creating short diffusion paths for the reacting molecules to the photocatalyst. Furthermore, keeping the main flow of the two liquids at the two sides of the contactor, the mixing of the two phases is kept to a minimum, thus avoiding dilution, before the photocatalytic reaction takes place.

Treatment of Gas; Gas/Gas Configuration

In the same way as for liquid-gas or liquid-liquid configuration the photocatalytic membrane contactor may operate in the gas-gas mode. In this operation the two gases are diffusing from opposite sides into the porous contactor containing the photocatalyst or being catalytic by itself. By pressure control of the gas at the two sides of the contactor a well defined transport rate of the two gases will take place resulting in a narrow region where the gases meet. By placing the photocatalyst in this region a high concentration of reactants will meet close to the photocatalyst which may benefit the reaction rate. The two phases continuously flow along the membrane at the opposite surface and reaction takes place in or on the surface of the membrane where two phases meet by diffusion as described above. The membrane contactor configuration allows not only consecutive reaction but also the controlled mixing of the two phases that can significantly improve the safety of the reaction such as H₂O₂ production from hydrogen and oxygen where hydrogen and oxygen mixture gas is explosive over a wide range of the composition. A similar concept has been described in the literature (e.g. J. Caro et al, Ind. Eng. Chem. Res., 46, 2286 2294, 2007), for a membrane contactor, but this was without a photocatalyst and light. In the case of photo-catalytic membrane contactors, where two gas phases are separated by the membrane, the conversion rate increases with the membrane length as the contact time of reactants and catalyst increases. The contactor configuration is also profitable to avoid any side reactions by mixing large volume of gaseous species, such as H₂O₂ production from hydrogen and oxygen as described earlier. The membrane contactor can provide reactants to the reaction zone continuously with a controlled mass and has a possibility to maintain the partial pressure of one or more reactants at the reaction zone.

The principle of the photocatalytic reaction in combination with the catalytic membrane contactor can be further explained by FIG. 2. The photocatalytic reaction can be oxidation, reduction or a combination of oxidation and reduction such as halogenation, anilation, hydroxylation, dehydration, dehalogenation, dimerization, annulation or Photo-Kolbe reaction.

The flow direction of the two phases may be counter flow as indicated by arrows on FIG. 2. However, parallel flow is also a possible configuration. In FIG. 2 catalysts 4 are immobilised in the porous support 5. The interface of two phases is maintained by pressure. In case of liquid and gas reactions, gaseous molecules, supplied from one side of the contactor, dissolve into water in the pores of the contactor and diffuse to the catalytic surface 1. Chemicals in liquid diffuse through pores from the other side to the catalytic surface 2. Light is supplied from either or both sides of the membrane 6. Reaction occurs on the catalyst and reaction products diffuse through the pores and are released to gas side and/or liquid side 3.

In case of oxidation, organics in liquid will be oxidized by the reaction and becomes carbon dioxide and water if full oxidation occurs. In case of reduction, toxic halogenated components will be reduced to less toxic component by replacing the halogen atoms by hydrogen atoms or reducing metal ion to metal that does not dissolve in the liquid and can be easily removed from the liquid. In other cases, atoms may be substituted by other atoms, such as hydrogen is substituted by chlorine in chlorination reaction. Ion exchange reactions are examples where end product(s) are neither oxidised nor reduced compared to the reactant(s).

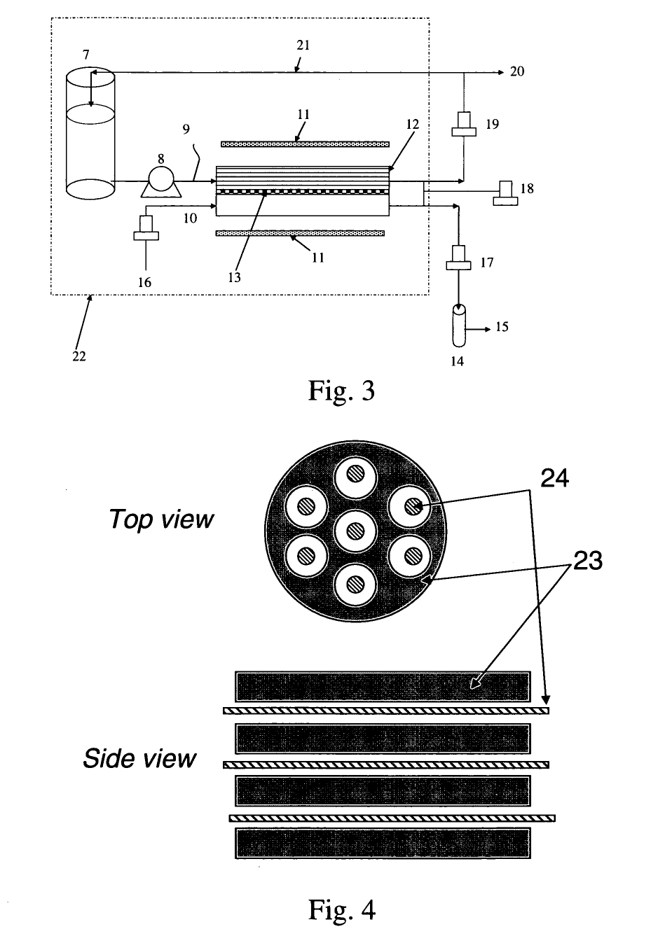

FIG. 3 shows a typical flow chart of the catalytic membrane contactor according to the invention. The gas, liquid or suspension containing organics to be reacted (phase A) is in tank 7 and supplied with a controlled flow rate by a pump 8 to the catalytic membrane contactor unit 12. The contactor unit 12 has a window at the light source side that penetrates the light. The window material can be quarts or polymers that have high transmittance. The gas or liquid flows on one side of the catalytic membrane contactor 13. The gas or liquid pressure is controlled by a back pressure valve 19. Another phase (phase B) that can be 1) oxidizing agent, which can be air, oxygen, enriched air, hydrogen peroxide, ozone or other oxidizing agent, 2) the reducing agent, which can be hydrogen or 3) accessory agent, which can be water, methanol in liquid form or vapour form, is introduced to the other side of the catalytic membrane contactor by a line 10 with a controlled flow rate by a flow meter 16. The line pressure is controlled by a back pressure valve 17. The pressure difference across the catalytic membrane contactor is measured by a pressure gauge 18. Light, which can come from a UV lamp, a black lamp, a white light lamp or any other type of lamp, or be sun light, can be irradiated at the liquid side, at the gas side or at both sides 11. The temperature at the membrane contactor is measured by a thermocouple 9 and maintained by a cooling or heating system 22 around the membrane contactor 12 and the feed tank 7. The outlet of the gas may be connected to a condenser 14 to separate liquid and gas phases before the exhaust 15. The outlet of the liquid or gas can be connected to a recycling line 21 to maintain the pressure or heat at the phase A side by flowing partial liquid or gas back to the feed tank 7. Reacted phase, such as oxidized solution, can be taken out from the system by a line 20.

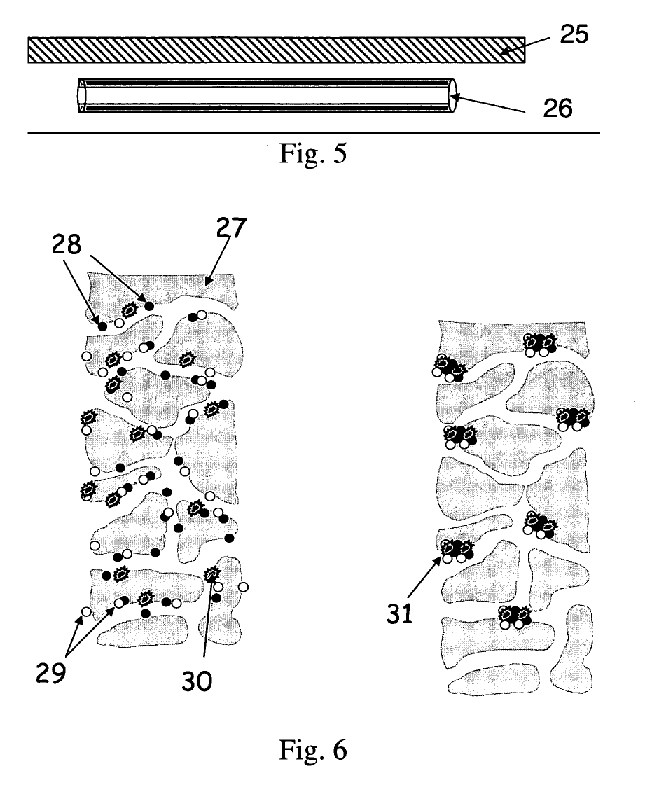

In FIGS. 4 and 5 two examples of light source installations are shown. The catalytic membrane contactor can have flat, tubular, capillary, multi-channel or other structures. In case of multi-channel structure 23, the light source 24 can be located in each channel as shown in FIG. 3. Light source 25 can be located at the outer surface of the support 26.

FIG. 6 shows a microstructure of the catalytic membrane contactor. Metal catalysts 28, such as Pt, Ru, Au, are immobilized in or on the porous membrane 27 as particles. Photocatalysts 29 are immobilized either individually or together with the metal catalysts. Adsorbents 30 can also be combined to increase the organic concentration around the catalyst. Metal and photocatalysts and adsorbents can be immobilised in or on the support as composite particle 31.

The photocatalyst can be TiO₂, tantalum oxide (TaOₓ), strontium titanate (SrTiO₃), vanadium oxide (VOₓ), niobium oxyfluohdes (NbOₓF_{y}) and oxides and oxyfluorides doped with either one or more ion(s) such as carbon, nitrogen, sulfur, silver, gold. The photocatalyst can also have the composition reported as charge-transfer catalyst such as diamond particles and silver composite (WO/2006/082671). Conventional catalysts can be used in combination with the photocatalysts. Catalysts can be formed as a composite with absorbents that increase the concentration of the organics around the catalyst.

Reaction speed generally has a linear relation with the reactant concentration. Material transport in the liquid phase can be the limiting step of the whole reaction in some operation conditions. Applying adsorbents close to the catalyst/photocatalyst may significantly increase the concentration of the reactant at the catalyst.

In more details, adsorbed reactants on the adsorbents will be transferred to the catalytic surface by surface diffusion and reaction occurs on the catalyst. The surface diffusion is generally faster than diffusion in liquid. In this way, applying adsorbents will improve the mass trans-port of the reactants to the catalysts. Adsorbents can for example be boehmite, SiO₂, carbon, clays and SiC.

The inventive process has a light source as an additional facility to the prior art. This light source can be UV lamp, white light lamp and sun light.

The oxidizing agents on the gas side of the membrane can be O₂, air, enriched air, ozone, H₂O₂ or other oxidising substances. In addition, the gas can be a reducing gas such as hydrogen gas (H₂). This embodiment is of special interest when there are contaminants like halogenated compounds which are highly toxic. Halogenated compounds can be dehalogenated to inorganic acid and less toxic organics. The contactor offers faster transport and appropriate reaction field. The dehalogenation of halogenated compounds (C—X) can be expressed by the following reaction:

C—X+H₂→C—H+HX

where X is a halogen.

The membrane contactor is applied in the process in the same way as the WaterCatox process. The membrane contactor can be a porous inorganic, polymeric or hybrid (inorganic and polymer composite) material having pore size of 0.001-10 μm, preferably 0.01-1 μm.

### Example 1

### Comparison of the Process According to the Invention with Conventional WaterCatox Process and Fixed Photocatalyst without Air Supply System in Formic Acid Oxidation

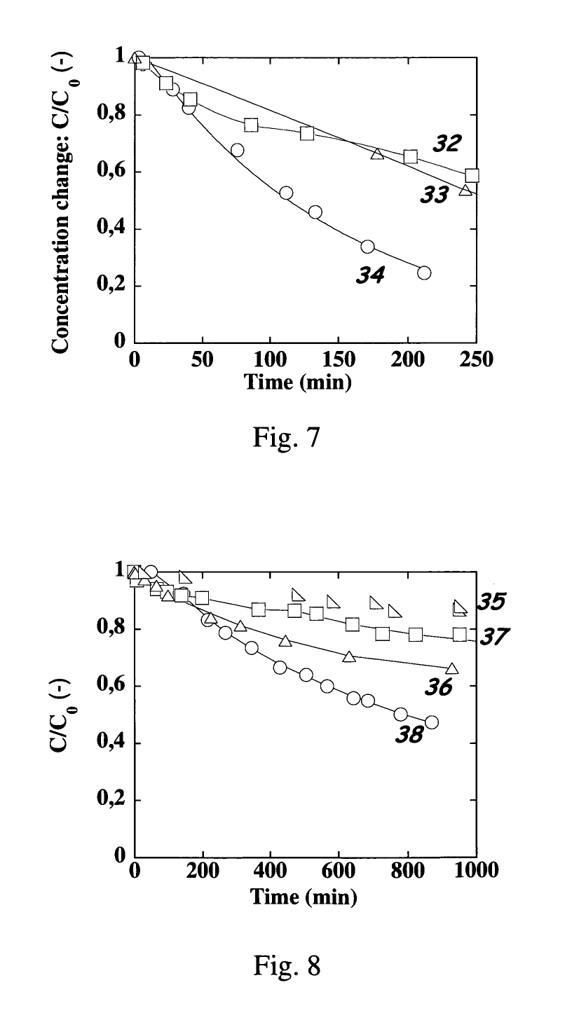

0.4 g/l formic acid solution and gas were supplied to the membrane contactor having 30 cm length and 10 mm outer diameter with 1 and 6 bar pressure, respectively. Four pieces of black lamps of 2 OW were placed around the tubular membrane contactor as the light source. The tests were performed at 30° C. The concentration of formic acid was measured by a UV spectrometer. Pt and TiO₂ composite catalysts were immobilised in and on a porous ceramic membrane. The test results are schematically presented in FIG. 7. The X-axis represents the time from the start of the test to the time when the sample was taken. The Y-axis represents the concentration change from the start.

When neither oxygen nor light was supplied, the concentration of formic acid was almost the same in 250 minutes, showing that the evaporation influence is negligible.

Three different tests were performed. In the first case, a lamp supplied light energy to the photocatalyst but no oxygen was introduced. This condition represents the fixed photocatalyst reactor without gas supply. Formic acid concentration (32) decreased with treatment time. Approximately 40% of the formic acid was decomposed after 250 minutes treatment.

In the second test, the lamp was turned off but pressurized oxygen flew on one side of the membrane contactor. This condition represents the conventional WaterCatox process. Formic acid concentration (33) decreased with a similar oxidation rate as the first test (32). Approximately 40% of the formic acid was decomposed after 250 minutes treatment.

In the third test, the lamp was turned on and pressurized oxygen flew on one side of the membrane contactor. This condition represents the process according to the invention. Formic acid oxidation is much faster than the former two cases (34). Approximately 40% oxidation was obtained in 85 minutes, which is about ⅓ duration compared to the former two cases. The results clearly show the advantage of the new process.

### Example 2

### Comparison of the Process According to the Invention with Conventional WaterCatox Process and Fixed Photocatalyst without Air Supply System in Humic Acid Oxidation

17 μg/l humic acid solution and gas were supplied to the membrane contactor with 1 and 6 bar pressure, respectively. The tests were performed at 30° C. The concentration of humic acid was measured by a UV spectrometer. Pt and TiO₂ composite catalysts were immobilised in and on a porous ceramic membrane. The test results are schematically presented in FIG. 8. The X-axis represents the time from the start of the test to the time when the sample was taken. The Y-axis represents the concentration change from the start.

Four different tests were performed. In the first case, the influence of humic acid was examined. Humic acid concentration (35) decreased with time of the liquid circulation and reached to the steady state after about 400 minutes. Approximately 15% of the humic acid was removed from the liquid by adsorption.

In the second test, UV lamp (black lamp) supplied light energy to the photocatalyst but no oxygen was introduced. This condition represents the fixed photocatalyst reactor without gas supply. Humic acid concentration (36) decreased with treatment time. The decrease of the concentration was faster than that caused by adsorption (35). Apparently photo-catalytic oxidation contributed to the decomposition of humic acid. Approximately 35% of the humic acid was removed after 900 minutes treatment.

In the third test, the lamp was turned off but pressurized oxygen flew on one side of the membrane contactor. This condition represents the conventional WaterCatox process. Humic acid concentration (37) decreased with a slightly faster rate than the adsorption (35). The conventional WaterCatox process can decompose humic acid but the oxidation rate is very slow.

In the forth test, lamp was turned on and pressurized oxygen flew on one side of the membrane contactor. This condition represents the process according to the invention. The concentration decrease of humic acid is the fastest among the four cases (38). More than 50% of humic acid was removed after 800 minutes treatment. 30% of humic acid was removed in 400 minutes, which is about ½ duration compared to the fixed photocatalyst reactor without gas supply and about ⅓ duration compared to the conventional WaterCatox process. The results clearly show the advantage of the new process.

### Example 3

### Gas-Gas Contactor with Inert/Activated Gas and Organic Vapour

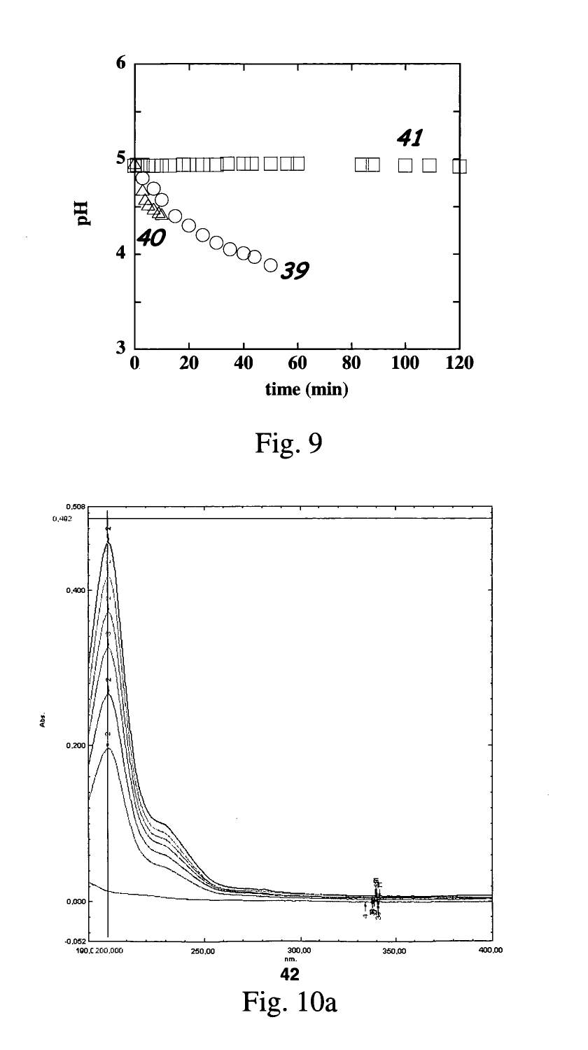

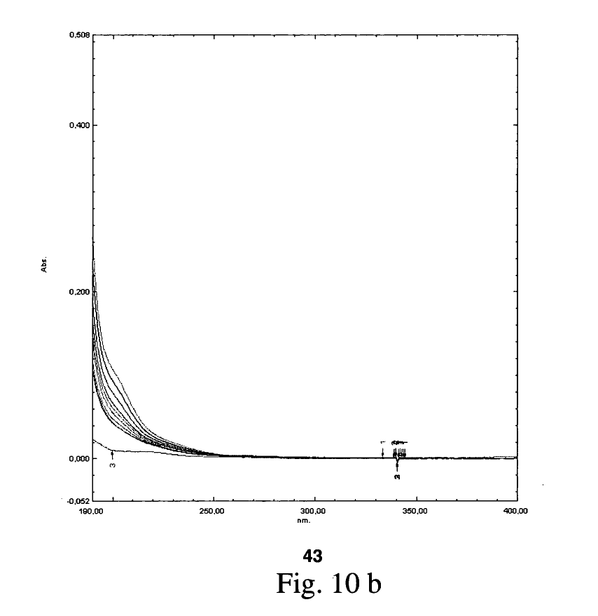

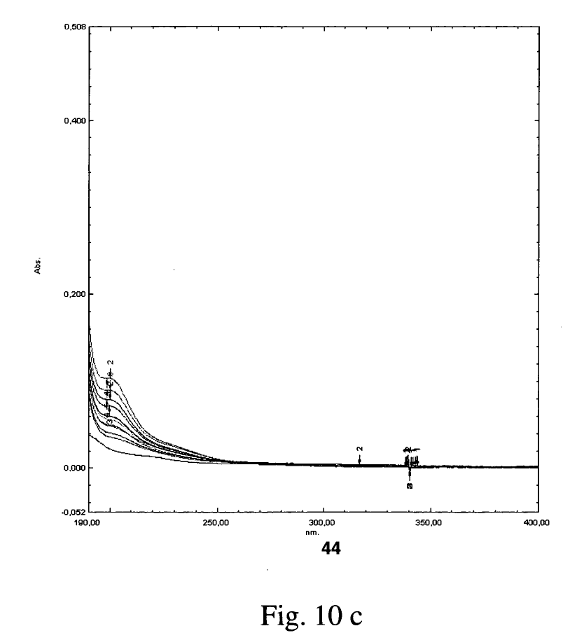

Formic acid vapour was supplied to the outer surface of the membrane contactor balanced with nitrogen. Inorganic gas, either nitrogen or oxygen, was supplied to the inner surface of the membrane contactor. Both gases were supplied at 1 bar pressure. Flow rate of the gases were maintained to 40 mL/min. Pt and TiO₂ composite catalysts were immobilised at the outer surface of the membrane contactor. Black lamps were used as UV light source. The tests were performed at 30° C. Exhaust gases were scrubbed by water to trap any soluble gases in the exhaust gas. UV absorption values and pH of the scrubbing water were measured. The test results are schematically presented in FIGS. 9 and 10a, 10b and 10c. The X-axis of FIG. 9 represents the time from the start of the test to the time when the sample was taken. The Y-axis represents the pH change from the start. FIGS. 10a, 10b and 10c shows the change of UV absorption spectrum with time at three different test conditions as described in the following.

Three tests were performed. In the first test, no light was applied and nitrogen was supplied to the inner surface of the membrane contactor. Reaction did not occur under this condition. Formic acid came out from the membrane contactor and dissolved into water as:

HCOOH+H₂O [symbol] COO⁻+H⁺

Accordingly, pH value also decreased with time (39). UV spectrum of the scrubbing water corresponded well with that of formic acid (42). The absorbance value showing the concentration of formic acid increased linearly with time.

In the second test, UV light (black lamp) was applied and oxygen was supplied to the inner surface of the membrane contactor. The formic acid peak almost disappeared from the UV spectrum (43), suggesting formic acid was oxidized by the membrane contactor as:

HCOOH+(O)→CO2+H2O

Formed CO2 will dissolve to water as:

CO₂+H₂O [symbol] HCO₃⁻+H

HCO₃⁻ [symbol] CO₃²⁻+H⁺

By above reactions, pH of the scrubbing water decreased with time (40).

In the third test, UV light (black lamp) was applied and nitrogen was supplied to the inner surface of the membrane contactor. The formic acid peak almost disappeared from the UV spectrum (44), suggesting formic acid was consumed by a chemical reaction. A small peak was observed in the UV spectrum around 200 nm that corresponds to C═O bond. On the contrary, the pH value was kept constant (41), suggesting much less CO₂ and formic acid existed in the exhaust gas compared to the case when oxygen was applied (40) even though other conditions were the same. The product composition was not determined but above results may suggest a new chemical formation.

As seen above, the reaction product coming out from the membrane contactor can be controlled by simply changing the gas type flowing at the opposite side of the membrane contactor to the reactant stream.

### Example 4

### Gas-Gas Contactor with Dry and Wet Conditions

Formic acid vapour was supplied to the outer surface of the membrane contactor balanced with nitrogen. Oxygen was supplied to the inner surface of the membrane contactor. Both gases were supplied at 1 bar pressure. Pt and TiO₂ composite catalysts were immobilised at the outer surface of the membrane contactor. The tests were performed at 30° C. with dry and wet conditions. Exhaust gases were scrubbed by water to trap any soluble gases in the exhaust gas. UV absorption values and pH of the scrubbing water were measured. The test results are schematically presented in Table 1.

When dry gas was applied about 50% of the formic acid was decomposed by the photocatalytic membrane contactor. On the contrary, 99% of the formic acid was decomposed when some humidity coexisted. Oxidation became significantly faster, which may be due to the OH radical, a strong oxidant, formation from water by the photo-reaction. In the presence of water, formic acid may have decomposed both by direct photo-catalysis and by OH radical.

The results show the possibility to control the exhaust composition without changing the feed stream condition but by changing the water vapour at the other side of the membrane.

TABLE 1

| | HCOOH decomposed |
|---|---|
| | by the membrane |
| | contactor (1 − Cₒᵤₜ/Cᵢₙ) |
| Dry conditions | 0.5 |
| Wet conditions | 0.99 |

In the Table 1, Cₒᵤₜ means the mass concentration at the outlet of the reactor and Cᵢₙ means the mass concentration at the inlet of the reactor.

### INDUSTRIAL APPLICATION

The present invention provides several applications.

Water cleaning, especially reduction of organic material in water is of special interest.

Air clearing, such as decomposing volatile organic components (VOC), is another potential application of photo-catalytic membrane reactor.

Chemical production is another potential application field of photocatalytic membrane reactors since photocatalysts have both oxidizing and reducing properties. Photocatalysts have been applied to many different applications; for example CO₂ reduction to hydrocarbons, photo-Kolbe reactions, amino acid production from ammonia, partial oxidation of hydrocarbons, photodimehzation and other reactions. Addition of water vapour is reported to increase significantly the photo-reaction rate and also affects the yield composition (e.g. S. Sato, The Journal of Physical Chemistry, 87, 3531-3537 (1983)). The vapour pressure of e.g. water also affects both the reaction rate and selectivity. Therefore, better control on the gaseous mixture composition is important in some reactions. A catalytic membrane reactor can not only realize a continuous reaction but also has an advantage in controlling e.g. the water vapour pressure at the place where reaction occurs that may improve conversion and/or selectivity.

1. Process for treating a liquid and/or gas phase, comprising:
using a catalytic membrane reactor in which the liquid and/or gas phase to be treated and a second phase are separated by a porous membrane, the porous membrane comprising at least one of a photocatalyst and a charge-transfer material based on surface modified materials and composite nano-materials; and
illuminating said phases by a light source to provide a photocatalytic reaction.

2. Process according to claim 1, wherein the phase to be treated is liquid and the second phase is gas.

3. Process according to claim 1, wherein the phase to be treated and the second phase is gas.

4. Process according to claim 1, wherein the phase to be treated and the second phase are liquid.

5. Process according to claim 1, wherein the photocatalytic reaction is one of oxidation, reduction or combination of oxidation and reduction where the end product or products is/are neither oxidized nor reduced compared to the reactant or reactants.

6. Process according to claim 1, wherein a conventional catalyst is used in combination with at least one of the photocatalyst or the charge-transfer material.

7. Process according to claim 1, wherein the catalyst is formed as a composite with adsorbents.

8. Process according to claim 7, wherein the adsorbent consists of organic materials, inorganic materials and hybrid (organic/inorganic) materials.

9. Process according to claim 1, wherein the light source is UV-light, white light, IR light, sun light or electromagnetic radiation with longer wavelength than IR light in particular of charge transfer material.

10. Process according to claim 1 wherein the second phase comprises oxidising agents.

11. Process according to claim 10, wherein the oxidising agent is any of O₂, air, oxygen-enriched air, ozone or H₂O₂ either pure or mixed with other gases.

12. Process according to claim 1 wherein the second phase comprises reducing agents.

13. Process according to claim 12, where the reducing agent is hydrogen or carbon monoxide either pure or mixed with non-oxidizing gases.

14. Catalytic membrane reactor comprising
a contactor in the form of a porous membrane comprising a catalyst material, the contactor being designed as a contactor between two phases;
wherein the porous membrane comprises at least one of a photocatalyst and charge-transfer material based on surface modified materials and composite nano-materials; and
a light source.

15. Catalytic membrane reactor according to claim 14, wherein the porous membrane comprises charge-transfer material based on surface modified materials and composite nano-materials and the light source comprises a long wave length light source.

16. Catalytic membrane reactor according to claim 14, wherein metal catalyst, photocatalysts and adsorbents are immobilised in or on the support as composite particle.
